(19) United States
(12) Patent Application Publication
(10) Pub. No.: US 2026/0169904 A1
(43) Pub. Date: Jun. 18, 2026

(54) AUTOMATED TESTING FRAMEWORK FOR STREAMLINING USER ACCEPTANCE TESTING (UAT) AND EXTERNAL CLIENT TESTING USING MACHINE LEARNING OPTIMIZATION

(71) Applicant: JPMORGAN CHASE BANK, N.A., New York, NY (US)

(72) Inventor: Yingzhao ZHOU, Hook (GB)

(21) Appl. No.: 18/985,390

(22) Filed: Dec. 18, 2024

(51) Int. Cl. G06F 11/3698; G06F 11/3668

(52) U.S. Cl. CPC G06F 11/3698; G06F 11/3684; G06F 11/3692; G06F 11/3696

(57) ABSTRACT

Systems and methods are disclosed including methods and techniques for software testing including steps of retrieve, by a test data automation tool executed by one or more processors, outside data from an outside data source, the outside data related to a software function; profile, by the test data automation tool, the outside data into one or more categories based on comparison, by a machine learning model, of the outside data with one or more categories, wherein one of the one or more categories is a bucket of anomalous data that is not otherwise categorized; receiving, by a test case generation machine learning model executed by one or more processors, a software program and one or more requirements for the software program; and generating, by the test case generation machine learning model, a test case based on the one or more requirements and one or more portions of the software program.

### BACKGROUND

### 1. Field of The Invention

Embodiments generally relate to systems and methods for user acceptance testing and external client testing using machine learning optimization.

### 2. Description of the Related Art

User Acceptance Testing (UAT) and External Client Testing are critical phases in software development, aimed at validating functionality, usability, and performance of software systems before deployment. Validating software before deployment is critical in order to ensure software operates as intended, without security breaches and errors. However, manual testing processes are often time-consuming, resource-intensive, and error-prone, leading to delays, inefficiencies, and increased costs. There is a need for an automated testing framework that can streamline these processes and enhance the overall quality of software testing outcomes.

### SUMMARY

According to some embodiments, systems and methods are disclosed including methods and techniques for software testing including steps of receiving a feature file of comprising a requirement and a test case; generating synthetic data from one or more historical payment transactions; generating a test scenario that includes a combination of input values for each requirement according to the test case; and interacting with incidents.

According to some embodiments, systems and methods are disclosed including methods and techniques for software testing including steps to retrieve, by a test data automation tool executed by one or more processors, outside data from an outside data source, the outside data related to a software function; profile, by the test data automation tool, the outside data into one or more categories based on comparison, by a machine learning model, of the outside data with one or more categories, wherein one of the one or more categories is a bucket of anomalous data that is not otherwise categorized; receive, by the test data automation tool, production data; profile, by the test data automation tool, the production data into the one or more categories; receiving, by a test case generation machine learning model executed by one or more processors, a software program and one or more requirements for the software program; generating, by the test case generation machine learning model, a test case based on the one or more requirements and one or more portions of the software program; orchestrate, by a computer program executed by one or more processors, execution of the test case using data of the one or more categories in a closed environment using a straight through protocol; generate, by the computer program, a script to edit the software program based on the test case; and execute the script to edit the software program.

In some embodiments, the method may further comprise wherein the machine learning model determines categories based on semantic similarity of data of one or more fields being below a threshold. In some embodiments, the method may further comprise wherein the machine learning model determines categories based on semantic similarity of data of one or more denotations being below a threshold. In some embodiments, the method may further comprise wherein the machine learning model produces synthetic data for one or more categories based on semantic similarity of synthetic data being below a threshold. In some embodiments, the method may further comprise wherein the machine learning model assigns weights to the synthetic data as compared to the production data. In some embodiments, the method may further comprise generating a report of aggregate runs of test cases showing passes and fails according to the one or more categories of data. In some embodiments, the method may further comprise generating a report of run times of each test case with different data.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for user acceptance testing and external client testing.

FIG. 2 illustrates a method for user acceptance testing and external client testing.

FIG. 3 illustrates a method for user acceptance testing and external client testing.

FIG. 4 is a block diagram of a computing device for implementing certain aspects of the present disclosure.

### DETAILED DESCRIPTION

Embodiments generally relate to systems and methods for providing machine learning based generation of frequently asked questions.

Conventionally, expert personnel must manually test software such as an application. This typically occurs in stages using only portions of the code. However, when the portions are combined and integrated, new issues may arise including differences in terminology or syntax, unexpected inputs/outputs of different code portions, failed links, and so on. These errors must each be fixed before the application can function as a cohesive unit.

Embodiments include leveraging advanced machine learning (ML) techniques, the framework optimizes manual processes involved in test case generation, execution, and analysis, leading to improved efficiency, accuracy, and reliability in software testing workflows. Embodiments utilize machine learning algorithms to automate and optimize various aspects of software testing including UAT and External Client Testing. Key features of the framework include: test case generation, test case prioritization, test execution optimization, defect prediction and prevention, and test analysis and reporting.

Test case generation may include a ML model analyzing historical test data, requirements documents, and user feedback to automatically generate comprehensive test cases and scenarios, covering a wide range of use cases and edge conditions.

Test case prioritization may include a ML algorithm prioritizing test cases based on factors such as criticality, impact, and risk, ensuring efficient allocation of testing resources and focus on high-priority areas.

Test execution optimization may include a ML-driven test execution strategy to dynamically adjust test schedules, sequences, and configurations based on real-time feedback, resource availability, and project timelines, maximizing test coverage and efficiency.

Defect prediction and prevention may include a ML model configured to analyze test results, code changes, and system metrics to predict potential defects and performance issues proactively, enabling early detection and prevention of software defects.

Test analysis and reporting may include a ML model that aggregates, analyzes, and visualizes test data, providing actionable insights, trends, and recommendations to stakeholders, facilitating data-driven decision-making and continuous improvement in testing processes.

Benefits of embodiments include enhanced efficiency due to reducing or eliminating manual input, accelerated test cycles, and improved testing. Enhanced efficiency may lead to faster time-to-market and reduced development costs. Benefits of embodiments also include improved accuracy due to optimization and reliability of test results. Better test results may reduce the presence or likelihood of defects or errors in a production model and thus reducing update costs. Benefits of embodiments also include adaptability because ML models continuously learn and evolve from user data and production incident feedback. Improving adaptability allows an increased ability to change project requirements or technologies immediately. Benefits of embodiments also include scalability because a modular framework enables replicability including integration with existing testing tools or environments. The replicability may be possible over different teams, networks, and/or industries.

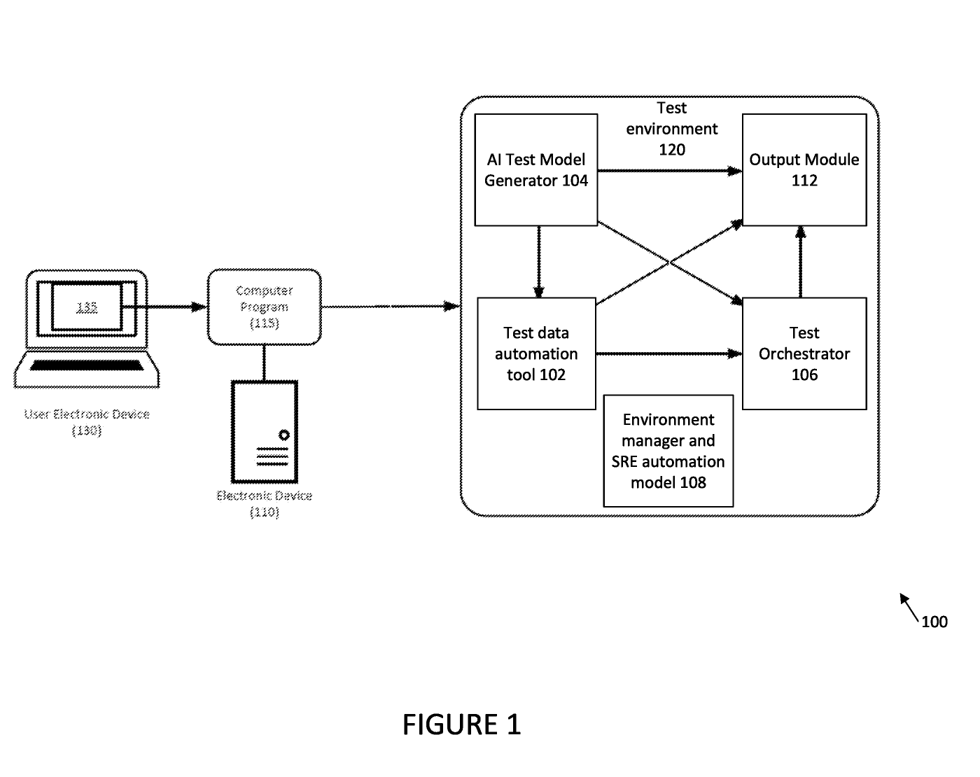

Referring to FIG. 1, a system 100 for test modeling, user acceptance testing, and/or external client testing is illustrated.

Referring to FIG. 1, a system for machine-learning based test modeling is disclosed according to an embodiment. System 100 may include electronic device 110, which may be any suitable electronic device, such as servers (e.g., cloud-based and/or physical), computers (e.g., workstations, desktops, laptops, notebooks, tablets, etc.), smart devices (e.g., smartphones, smart watches, etc.), Internet of Things (IoT) appliances, etc. Electronic device 110 may execute computer program 115, which may be a computer program or application that may return a test model output. In one embodiment, computer program 115 may be a distributed application which may be distributed to other electronic devices, such as user electronic device 130.

Computer program 115 may receive instructions from a user such as input training data, historical data, target data, historical test models, and/or a target test model. For example, a user may enter a location of the data or test model and the computer program 115 may pull appropriate data and/or portion of a test model as appropriate and discussed further herein. In one embodiment, computer program 115 may generate and execute tests using test environment 120. Test environment 120 may be a platform such as a virtual machine, an operating system, or an application operating on a computer network and may include a machine learning model that is trained using, for example, supervised training, using historical data, and then validated.

In one embodiment, test environment 120 may include one or more software modules executed by one or more processors including one or more of a test data automation tool 102, an artificial intelligence (AI) test model generator 104, a test orchestrator 106, an environment manager and SRE automation model 108, and an output module 112.

Test data automation tool 102 may retrieve outside data from an outside data source. The data may be an electronic document with one or more fields that are taken as requirements. In some embodiments, the electronic document may be entered via optical character recognition. The one or more fields may be filled with business information, transaction information, payment fulfillment information, user information, or data profile information. The outside data source may be the internet, a local network memory, a cloud, or a network memory. Test data automation tool 102 may profile the data from various sources and provide analytics on the data. The test data automation tool 102 may include a machine learning engine or be in operative communication with a machine learning engine. The machine learning engine may categorize the received data. The machine learning engine may categorize one or more fields of the received data. The machine learning engine may determine analytics for the data and/or the fields including a number of the same or similar fields, a number of distinct documents, and/or a number of field entries. Data, fields, characters, words, phrases, and/or entries may be compared based on semantic similarity. In some embodiments, test cases from pairwise test coverage and optimization may be configured to generate one or more profiles, categorization of data according to historical test data, requirements, or user feedback.

The artificial intelligence test model generator 104 may comprise a machine learning model to develop one or more test case generation machine learning models. The artificial intelligence test model generator 104 may generate one or more machine learning models or an instance of the one or more machine learning models based on analysis of historical test data, requirements documents, and user feedback to automatically generate comprehensive test cases and scenarios, covering a wide range of use cases and edge conditions. The artificial intelligence test model generator 104 may train a test case generation machine learning model to generate a test case based on the one or more historical examples and the one or more requirements and/or user feedback.

The test orchestrator 106 may input different combinations of requirements (e.g., scenarios) based on the functional specification into generated test models from AI test model generator 104. The test models may be tested with various data from test data automation tool 102. The test orchestrator 106 may use a test environment (e.g., isolated workspace or instance) for the generated test cases and test data. The test orchestrator 106 may input the data systematically and/or record test results from each step to ensure failures are identified with specificity. The test orchestrator 106 may use straight through processing (STP), either modern or legacy STP, to systematically test the generated test cases. In some embodiments, deployment of a software program to an environment may trigger testing orchestration.

Environment management and site reliability engineering (“SRE”) automation model 108 may monitor test environment 120 to ensure creation and testing of test cases with production data. In some embodiments, the environment management and SRE automation model 108 may include an incidents application programming interface (“API”) that is an interface for programmatically interacting with incidents, enabling the generation of test cases that simulate error scenarios and feedback loop from production incidents to test creation.

Output module 112 may include reports, analytics, and/or a result or output of data input into a test model including pass/fail, a score, an efficiency, a computing resource consumed (e.g., memory, processor bandwidth or efficiency, run times). In some embodiments, hundreds or thousands of test cases may be aggregated into a report showing passes/fails and/or a score on a scale of 1 to 100 of a test case. The display may be displayed on an electronic display. The output may be an executable script to implement a modification to an existing software program to match a test case of a software system or component as a production model, the production model for example, is configured to process incoming data. The test case may ensure completeness, accuracy of entries/fields, and/or process and storage of data. The software system or component may, for example, authorize, block, or approve transactions, approve or block processing of communications, identify anomalies (e.g., a grouping, bucket, section of anomalous data) within large amounts of data including transaction histories, and/or generate executable script for processing data for faster and more efficient searching and/or organizing the data according to a hierarchy. In some embodiments, the output may be a prediction of defects and performance issues and generation of script to enable early detection and prevent software defects. In some embodiments, the type of data used (e.g., anomalous, missing one or more attributes, fields, or characters) may be recorded for each test to determine robustness and/or efficiency of the software system or component.

Once the tool is tested, computer program 115 may return an output from output module 112 including proposed edits to one or more software modules based on tests, script configured to implement edits on one or more software modules, a timeline of an installation of edits, results of one or more test models, which may be displayed for the user.

In one embodiment, computer program 115 may expose an application programming interface (API) for application 135.

In one embodiment, user electronic device 110 may include computer program 115 and/or test environment 120. Test environment 120 may be periodically updated by a backend (not shown). Thus, user electronic device 130 may not need to access any external computer programs to return a test model or test model results or output.

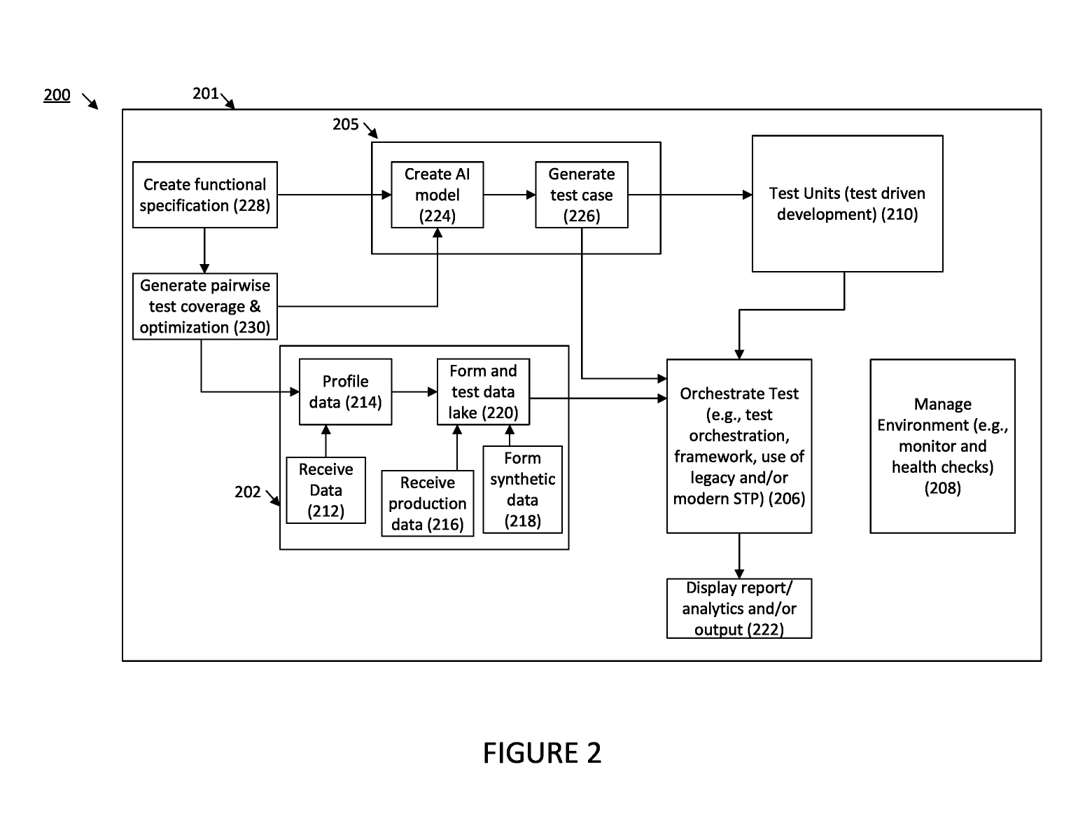

Referring to FIG. 2, a method 200 for test modeling, user acceptance testing, and/or external client testing is illustrated. Method 100 may be as steps stored on a memory and executed by one or more processors, the computers, network devices, or electronic communication devices including a memory and one or more processors. Method 200 may be executed by one or more software components including a computer program 201, a test data automation tool 202, and an artificial intelligence (AI) test model generator 204.

In step 212, a test data automation tool 202 may retrieve outside data from an outside data source. The data may be an electronic document with one or more fields that are taken as requirements. In some embodiments, the electronic document may be entered via optical character recognition. The one or more fields may be filled with business information, transaction information, payment fulfillment information, user information, or data profile information. The outside data source may be the internet, a local network memory, a cloud, or a network memory.

In step 214, a test data automation tool 202 may profile the data and provide analytics on the data. The test data automation tool 202 may include a machine learning engine or be in operative communication with a machine learning engine. The machine learning engine may categorize the received data. The machine learning engine may categorize one or more fields of the received data. The machine learning engine may determine analytics for the data and/or the fields including a number of the same or similar fields, a number of distinct documents, and/or a number of field entries. Data, fields, characters, words, phrases, and/or entries may be compared based on semantic similarity. In some embodiments, test cases from pairwise test coverage and optimization of step 230 may be configured to generate one or more profiles, categorization of data according to historical test data, requirements, or user feedback.

In step 216, a test data automation tool 202 may receive production data from a database. Production data may be documents from a memory. Production data may be one or more electronic documents or forms, similar to those discussed above regarding step 212. Production data may be received from users or customers after use in an intended application such as transaction data such as a credit card or wire transfer, business contracts, business organization papers, or similar. The machine learning engine referred to above regarding step 212 may similarly identify fields and/or categories from production data (e.g., grouped based on title, semantic similarity of content). In some embodiments, personal identifiable information (PII) may be removed from production data.

In step 218, a test data automation tool 202 may form synthetic data. The synthetic data may be artificially-generated data. The synthetic data may resemble data from the production data including having a similar number of characters including in one or more fields and/or sections (e.g., denoted by titles, punctuation, indentation, or spacing), have some or all similar fields completed, and/or have similar or the same fields. In some embodiments, the machine learning engine of steps 212/214 may be used to generate the synthetic data based on production data and/or outside data including having same or similar fields, characters for some or all fields, including same or similar titles/punctuations/spacing, and/or a number of field entries. The machine learning engine may generate synthetic data based on patterns, anomalies, and/or trends of data, characters, fields, and/or entries of production data and/or outside data. Similarity may be based on semantic similarity measures. Categories may be formed when semantic similarity is above a threshold or different categories may be differentiated when semantic similarity is below a threshold.

In step 220, a test data automation tool 202 may form a data lake including using categories and/or analytics from step 214 and data from steps 216 and 218. In some embodiments, the machine learning engine of steps 212/214/218 may be used to categorize the data and/or assign positive or negative weights, or alternatively, relatively small or large weights, as compared to production data. The machine learning engine may generate synthetic data based on patterns, anomalies, and/or trends of data, characters, fields, and/or entries of production data and/or outside data. In some embodiments, the data lake may include a categorization of anomalous data, wherein the anomalous data cannot be categorized into previous examples. The anomalous data may be identified for test cases to determine robustness and efficiency of the one or more software programs.

In step 206, the computer program 201 or a module thereof may orchestrate a test of a test case from step 226 using data from the data lake of step 220.

In step 222, the computer program 201 or a module thereof may display a report, analytics, and/or output of the test case including pass/fail. In some embodiments, hundreds or thousands of test cases (e.g., runs) may be aggregated into a report showing passes/fails and/or a score on a scale of 1 to 100 of a test case. The display may be displayed on an electronic display. The output may be an executable script to implement a modification to an existing software program to match a test case of a software system or component as a production model, the production model for example, is configured to process incoming data. The test case may ensure completeness, accuracy of entries/fields, and/or process and storage of data. The software system or component may, for example, authorize, block, or approve transactions, approve or block processing of communications, identify anomalies within large amounts of data including transaction histories, and/or generate executable script for processing data for faster and more efficient searching and/or organizing the data according to a hierarchy. In some embodiments, the output may be a prediction of defects and performance issues and generation of script to enable early detection and prevent software defects. In some embodiments, the type of data used (e.g., anomalous, missing one or more attributes, fields, or characters) may be recorded for each test to determine robustness and/or efficiency of the software system or component.

In step 228, the computer program 201 may create a functional specification from historical test data, one or more requirements, and/or a user feedback. The historical test data may be of one or more software systems or components. The one or more software systems or components may be a production model, the production model for example, is configured to process incoming data. The functional specification may include a business function such as payments or a linear regional transaction; a template including one or more key attributes such as an amount, an account number, sender, or recipient, or examples such as a credit or debit transaction.

In step 230, the computer program 201 may generate test scenarios of input values for a given set of parameters from the requirements, historical test data, and/or user feedback. The benefit of the disclosed pairwise test coverage and optimization is the ability to create cover of a range of test coverage and to further reduce human test creation effort. The set of parameters may be tested with pairwise techniques to ensure coverage of many or all discrete combinations of test cases with different adjustments of parameters. The computer program 201 may generate logical parameters based on the inputs such as assigning a range to an input number, the range being modified/refined based on an aggregate of inputs.

In step 224, computer program 201 may supply requirements, user feedback, and historical examples to an artificial intelligence test model generator 204 comprising a machine learning model to develop one or more test case generation machine learning models. The artificial intelligence test model generator 204 may generate one or more machine learning models or an instance of the one or more machine learning models based on analysis of historical test data, requirements documents, and user feedback to automatically generate comprehensive test cases and scenarios, covering a wide range of use cases and edge conditions. The artificial intelligence test model generator 204 may train a test case generation machine learning model to generate a test case based on the one or more historical examples and the one or more requirements and/or user feedback. The test case generation machine learning model may be trained using different combinations of requirements based on the output of step 230. In some embodiments, the machine learning engine may be a large language model (“LLM”) that records examples for use or comparison. The machine learning engine may encode a business function, same or similar to business functions discussed herein, into a number to compare to other similar business functions.

In step 226, artificial intelligence test model generator 204 may generate test cases. The generated test cases may be distinct portions of code of the one or more software programs executed to interact with one or more software programs or portions of software programs to ensure capability, accuracy, and/or efficiency. Artificial intelligence test model generator 204 may generate distinct steps for portions of code to ensure capability, accuracy, and/or efficiency at each step.

In step 210, computer program 201 may test generated test cases from step 226 and develop, through communication of feedback with artificial intelligence test model generator 204, new test cases, or steps thereof, based on whether the generated test cases produce quality results. The quality of results may be measured based on whether test cases produce results that can be judged (e.g., pass, fail, a score, identifying a need for an entry/a field/a character).

In step 206, computer program 201 may input different combinations of requirements (e.g., scenarios) based on the functional specification into the generated test cases. Computer program 201 may execute the generated test cases from steps 226 and/or 210 using data from the data lake of step 220. The computer program 201 may use a test environment (e.g., isolated workspace, closed environment, or instance) for the generated test cases and data from the data lake. The computer program 201 may input the data systematically. The computer program 201 may use straight through processing (STP), either modern or legacy STP, to systematically test the generated test cases. In some embodiments, deployment of a software program to an environment may trigger testing orchestration.

In step 208, an environment management and site reliability engineering (“SRE”) automation model may monitor computer program 201 to ensure creation and testing of test cases with production data. In some embodiments, the environment management and SRE automation model may include an incidents application programming interface (“API”) that is an interface for programmatically interacting with incidents, enabling the generation of test cases that simulate error scenarios and feedback loop from production incidents to test creation.

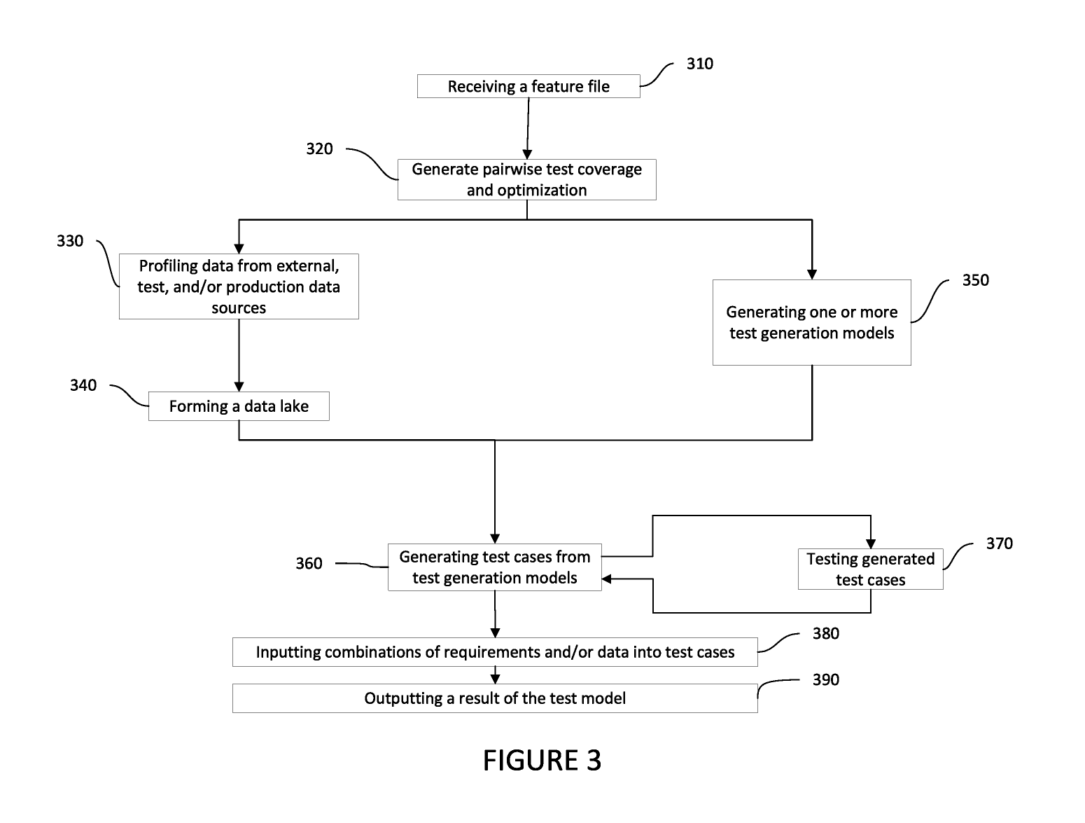

FIG. 3 illustrates a method for user acceptance testing and external client testing.

Step 310 includes receiving, by a computer program executed by one or more processors and in operative communication with a memory, and feature files. The feature files may be stored in the memory. Feature files may capture user files, acceptance criteria, and/or test scenarios. A feature file may include a functional specification from historical test data, one or more requirements, and/or a user feedback. The historical test data may be of one or more software systems or components. The one or more software systems or components may be a production model, the production model for example, is configured to process incoming data. The functional specification may include a business function such as payments or a linear regional transaction; a template including one or more key attributes such as an amount, an account number, sender, or recipient, or examples such as a credit or debit transaction.

Step 320 includes generating, by the computer program, pairwise test coverage and optimization by generating test scenarios of input values for a given set of parameters from the requirements, historical test data, and/or user feedback. The benefit of the disclosed pairwise test coverage and optimization is the ability to create cover of a range of test coverage and to further reduce human test creation effort. The set of parameters may be tested with pairwise techniques to ensure coverage of many or all discrete combinations of test cases with different adjustments of parameters. The computer program may generate logical parameters based on the inputs such as assigning a range to an input number, the range being modified/refined based on an aggregate of inputs.

Step 330 includes profiling, by a test data automation tool, data from various sources, including external data, test data, and production data, and providing analytics on the data. The test data automation tool may include a machine learning engine or be in operative communication with a machine learning engine. The machine learning engine may categorize the received data. The machine learning engine may categorize one or more fields of the received data. The machine learning engine may determine analytics for the data and/or the fields including a number of the same or similar fields, a number of distinct documents, and/or a number of field entries. In some embodiments, test cases from pairwise test coverage and optimization may be configured to generate one or more profiles, categorization of data according to historical test data, requirements, or user feedback.

Step 340 includes forming, by the test data automation tool, a data lake from the data including using categories and/or analytics. In some embodiments, the machine learning engine may be used to categorize the data and/or assign positive or negative weights, or alternatively, relatively small or large weights, as compared to production data. The machine learning engine may be configured to generate synthetic data from payment transactions. The payment transactions may be in a database of past payment transactions. The synthetic data may not include personal identifiable information (PII). The machine learning engine may generate synthetic data based on patterns, anomalies, and/or trends of data, characters, fields, and/or entries of production data and/or outside data. In some embodiments, the data lake may include a categorization of anomalous data, wherein the anomalous data cannot be categorized into previous examples. The anomalous data may be identified for test cases to determine robustness and efficiency of the one or more software programs. In some embodiments, a meta categorization may allow for data to be stored according to particular groups of test cases, and sub-categorization may allow for data to be stored according to commonality within the test cases with anomalous data being the least common. The categorization may allow for systemic, iterative testing of each data item.

Step 350 includes generating, by an artificial intelligence model comprising a machine learning model, one or more test case generation machine learning models from requirements, user feedback, and historical examples. The artificial intelligence model may determine one or more machine learning models or an instance of the one or more machine learning models based on analysis of historical test data, requirements documents, and user feedback to automatically generate comprehensive test cases and scenarios, covering a wide range of use cases and edge conditions. The artificial intelligence model may train a test case generation machine learning model to generate a test case based on the one or more historical examples and the one or more requirements and/or user feedback. The test case generation machine learning model may be trained using different combinations of requirements based on the pairwise test coverage and optimization. In some embodiments, the machine learning engine may be a large language model (“LLM”) that records examples for use or comparison. The machine learning engine may encode a business function, same or similar to business functions discussed herein, into a number to compare to other similar business functions.

Step 360 includes generating, by the generated test case models, test cases. The generated test cases may be distinct portions of code of the one or more software programs executed to interact with one or more software programs or portions of software programs to ensure capability, accuracy, and/or efficiency. Artificial intelligence model may generate distinct steps for portions of code to ensure capability, accuracy, and/or efficiency at each step.

Step 370 includes testing, by the computer program, generated test cases from the artificial intelligence model and developing, through communication of feedback with artificial intelligence model, new test cases, or steps thereof, based on whether the generated test cases produce quality results. The quality of results may be measured based on whether test cases produce results that can be judged (e.g., pass, fail, a score, identifying a need for an entry/a field/a character). Testing may include interacting with incidents, thus enabling the generation of test cases that simulate error scenarios and feedback loop from production incidents to test creation.

Step 380 includes inputting, by an orchestration module of the computer program, different combinations of requirements and/or data (e.g., scenarios) based on the functional specification into generated test models from AI test model generator. The test models may be tested with various data from test data automation tool. The test orchestrator may use a test environment (e.g., isolated workspace or instance) for the generated test cases and test data. The test orchestrator may input the data systematically and/or record test results from each step to ensure failures are identified with specificity. The test orchestrator may use straight through processing (STP), either modern or legacy STP, to systematically test the generated test cases. In some embodiments, deployment of a software program to an environment may trigger testing orchestration.

Step 390 includes outputting, by the computer program or a module thereof in operative communication with a display or a user interface capable of display, a report, analytics, and/or output of the test case including pass/fail or other measures of success or computing usage. In some embodiments, hundreds or thousands of test cases may be aggregated into a report showing passes/fails and/or a score on a scale of 1 to 100 of a test case. The display may be displayed on an electronic display. The output may be an executable script to implement a modification to an existing software program to match a test case of a software system or component as a production model, the production model for example, is configured to process incoming data. The test case may ensure completeness, accuracy of entries/fields, and/or process and storage of data. The software system or component may, for example, authorize, block, or approve transactions, approve or block processing of communications, identify anomalies within large amounts of data including transaction histories, and/or generate executable script for processing data for faster and more efficient searching and/or organizing the data according to a hierarchy. In some embodiments, the output may be a prediction of defects and performance issues and generation of script to enable early detection and prevent software defects. In some embodiments, the type of data used (e.g., anomalous, missing one or more attributes, fields, or characters) may be recorded for each test to determine robustness and/or efficiency of the software system or component.

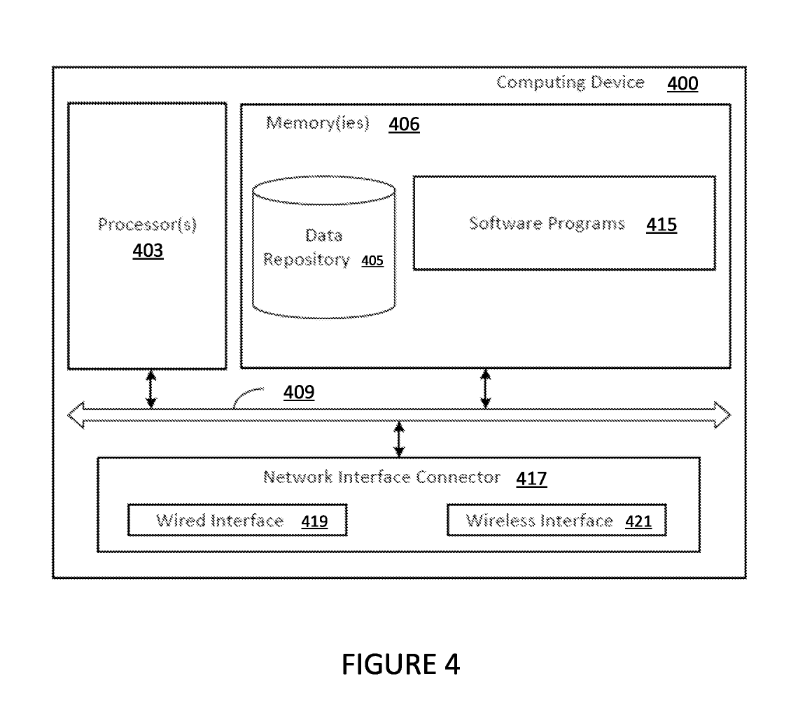

FIG. 4 is a block diagram of a computing device for implementing certain aspects of the present disclosure. FIG. 4 shows exemplary computing device 400. Computing device 400 may represent hardware that executes the logic that drives the various system components described herein. For example, system components such as a ML model engine, an interface, various database engines and database servers, and other computer applications and logic may include, and/or execute on, components and configurations like, or similar to, computing device 400.

Computing device 400 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 400 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method for software testing, the method comprising instructions stored on a memory that, when executed by one or more processors, cause the processor to:
retrieve, by a test data automation tool executed by one or more processors, outside data from an outside data source, the outside data related to a software function;
profile, by the test data automation tool, the outside data into one or more categories based on comparison, by a machine learning model, of the outside data with one or more categories, wherein one of the one or more categories is a bucket of anomalous data that is not otherwise categorized;
receive, by the test data automation tool, production data;
profile, by the test data automation tool, the production data into the one or more categories;
receiving, by a test case generation machine learning model executed by one or more processors, a software program and one or more requirements for the software program;
generating, by the test case generation machine learning model, a test case based on the one or more requirements and one or more portions of the software program;
orchestrate, by a computer program executed by one or more processors, execution of the test case using data of the one or more categories in a closed environment using a straight through protocol;
generate, by the computer program, a script to edit the software program based on the test case; and
execute the script to edit the software program.

2. The method of claim 1, wherein the machine learning model determines categories based on semantic similarity of data of one or more fields being below a threshold.

3. The method of claim 1, wherein the machine learning model determines categories based on semantic similarity of data of one or more denotations being below a threshold.

4. The method of claim 1, wherein the machine learning model produces synthetic data for one or more categories based on semantic similarity of synthetic data being below a threshold.

5. The method of claim 4, wherein the machine learning model assigns weights to the synthetic data as compared to the production data.

6. The method of claim 1, further comprising generating a report of aggregate runs of test cases showing passes and fails according to the one or more categories of data.

7. The method of claim 1, further comprising generating a report of run times of each test case with different data.

8. A computer processing system comprising:
a memory configured to store instructions; and
a hardware processor operatively coupled to the memory for executing the instructions of a test model processing program to:
retrieve, by a test data automation tool executed by one or more processors, outside data from an outside data source, the outside data related to a software function;
profile, by the test data automation tool, the outside data into one or more categories based on comparison, by a machine learning model, of the outside data with one or more categories, wherein one of the one or more categories is a bucket of anomalous data that is not otherwise categorized;
receive, by the test data automation tool, production data;
profile, by the test data automation tool, the production data into the one or more categories;
receiving, by a test case generation machine learning model executed by one or more processors, a software program and one or more requirements for the software program;
generating, by the test case generation machine learning model, a test case based on the one or more requirements and one or more portions of the software program;
orchestrate, by a computer program executed by one or more processors, execution of the test case using data of the one or more categories in a closed environment using a straight through protocol;
generate, by the computer program, a script to edit the software program based on the test case; and
execute the script to edit the software program.

9. The system of claim 8, wherein the machine learning model determines categories based on semantic similarity of data of one or more fields being below a threshold.

10. The system of claim 8, wherein the machine learning model determines categories based on semantic similarity of data of one or more denotations being below a threshold.

11. The system of claim 8, wherein the machine learning model produces synthetic data for one or more categories based on semantic similarity of synthetic data being below a threshold.

12. The system of claim 11, wherein the machine learning model assigns weights to the synthetic data as compared to the production data.

13. The system of claim 8, further comprising generating a report of aggregate runs of test cases showing passes and fails according to the one or more categories of data.

14. The system of claim 8, further comprising generating a report of run times of each test case with different data.

15. A non-transitory computer readable storage medium, including instructions stored thereon, which when read and executed by one or more computer processors, cause the one or more computer processors to perform steps comprising:
retrieve, by a test data automation tool executed by one or more processors, outside data from an outside data source, the outside data related to a software function;
profile, by the test data automation tool, the outside data into one or more categories based on comparison, by a machine learning model, of the outside data with one or more categories, wherein one of the one or more categories is a bucket of anomalous data that is not otherwise categorized;
receive, by the test data automation tool, production data;
profile, by the test data automation tool, the production data into the one or more categories;
receiving, by a test case generation machine learning model executed by one or more processors, a software program and one or more requirements for the software program;
generating, by the test case generation machine learning model, a test case based on the one or more requirements and one or more portions of the software program;
orchestrate, by a computer program executed by one or more processors, execution of the test case using data of the one or more categories in a closed environment using a straight through protocol;
generate, by the computer program, a script to edit the software program based on the test case; and
execute the script to edit the software program.

16. The non-transitory computer readable storage medium of claim 15, wherein the machine learning model determines categories based on semantic similarity of data of one or more fields being below a threshold.

17. The non-transitory computer readable storage medium of claim 15, wherein the machine learning model determines categories based on semantic similarity of data of one or more denotations being below a threshold.

18. The non-transitory computer readable storage medium of claim 15, wherein the machine learning model produces synthetic data for one or more categories based on semantic similarity of synthetic data being below a threshold.

19. The non-transitory computer readable storage medium of claim 18, wherein the machine learning model assigns weights to the synthetic data as compared to the production data.

20. The non-transitory computer readable storage medium of claim 15, further comprising generating a report of aggregate runs of test cases showing passes and fails according to the one or more categories of data.
